(19) United States
(12) Patent Application Publication
(10) Pub. No.: US 2024/0323442 A1
(43) Pub. Date: Sep. 26, 2024

(54) Encoding and Decoding Video Content Using Flexible Coefficient Position Signaling

(71) Applicant: Apple Inc., Cupertino, CA (US)

(72) Inventors: Alican Nalci, La Jolla, CA (US); Guoxin Jin, San Diego, CA (US); Hilmi Enes Egilmez, San Jose, CA (US); Hsi-Jung Wu, San Jose, CA (US); Jun Xin, San Jose, CA (US); Yixin Du, Milpitas, CA (US); Yunfei Zheng, Santa Clara, CA (US); Yeqing Wu, Cupertino, CA (US)

(21) Appl. No.: 18/603,138

(22) Filed: Mar. 12, 2024

Related U.S. Application Data
(60) Provisional application No. 63/453,741, filed on Mar. 21, 2023.

(51) Int. Cl. H04N 19/625; H04N 19/176; H04N 19/70

(52) U.S. Cl. CPC H04N 19/625; H04N 19/176; H04N 19/70

(57) ABSTRACT

In an example method, a decoder accesses a bitstream representing video content, and parses one or more flexible coefficient position (FCP) syntax from the bitstream, where the one or more FCP syntax indicate one or more index values. The decoder further determines side information representing one or more characteristics of an encoded portion of the video content. The decoder interprets the one or more FCP syntax based on the side information, including determining a coefficient position with respect to the encoded portion of the video content based on the one or more index values and the side information. The decoder decodes the encoded portion of the video content according to the coefficient position.

### CROSS-REFERENCE TO RELATED APPLICATION

This application claims priority to U.S. Provisional Patent Application No. 63/453,741, filed Mar. 21, 2023, the entire contents of which are incorporated herein by reference.

### TECHNICAL FIELD

This disclosure relates generally to encoding and decoding video content.

### BACKGROUND

Computer systems can be used to encode and decode video content. As an example, a first computer system can obtain video content, encode the video content in a compressed data format, and provide the encoded data to a second computer system. The second computer system can decode the encoded data, and generate a visual representation of the video content based on the decoded data.

### SUMMARY

In an aspect, a method includes: accessing, by one or more processors, a bitstream representing video content; parsing, by the one or more processors, one or more flexible coefficient position (FCP) syntax from the bitstream, where the one or more FCP syntax indicate one or more index values; determining, by the one or more processors, side information representing one or more characteristics of an encoded portion of the video content; interpreting, by the one or more processors, the one or more FCP syntax based on the side information, where interpreting the one or more FCP syntax includes determining a coefficient position with respect to the encoded portion of the video content based on the one or more index values and the side information; and decoding, by the one or more processors, the encoded portion of the video content according to the coefficient position.

Implementations of this aspect can include one or more of the following features.

In some implementations, the encoded portion of the video content can include at least one of a coding unit or a transform unit of the video content.

In some implementations, interpreting the one or more FCP syntax can include determining, based on the side information, whether the one or more FCP syntax represent (i) a sequentially first significant coefficient position of the encoded portion of the video content or (ii) a sequentially last significant coefficient position of the encoded portion of the video content.

In some implementations, interpreting the one or more FCP syntax can include determining, based on the side information, whether to decode the encoded portion of the video content according to a forward coefficient scan order or a reverse coefficient scan order.

In some implementations, interpreting the one or more FCP syntax can include determining, based on the side information, to decode the encoded portion of the video content according to the forward coefficient scan order. Decoding the encoded portion of the video content according to the coefficient position can include performing a forward coefficient scanning with respect to the encoded portion of the video content starting with the coefficient position, where the coefficient position is a first coded coefficient position.

In some implementations, interpreting the one or more FCP syntax can include determining, based on the side information, to decode the encoded portion of the video content according to the reverse coefficient scan order. Decoding the encoded portion of the video content according to the coefficient position can include performing a reverse coefficient scanning with respect to the encoded portion of the video content starting with the coefficient position, where the coefficient position is a last coded coefficient position.

In some implementations, the one or more FCP syntax entries can indicate a single index value. The coefficient position can be determined based on the single index value.

In some implementations, the one or more FCP syntax can indicate a plurality of index values. The coefficient position can be determined based on the plurality of index values.

In some implementations, the coefficient position can be determined based on one or more functions having at least some of the plurality of index values as inputs.

In some implementations, determining the side information can include determining at least one of: a transform type of the encoded portion of the video content, coding block dimensions of the encoded portion of the video content, a transform unit size of the encoded portion of the video content, a plane type of the encoded portion of the video content, a coding mode of the encoded portion of the video content, or information regarding one or more additional encoded portions of the video content neighboring the encoded portion of the video content.

In some implementations, determining the coefficient position with respect to the encoded portion of the video content can include determining a coefficient index value corresponding the coefficient position.

In some implementations, determining the coefficient position with respect to the encoded portion of the video content can include determining a coefficient column value corresponding the coefficient position.

In some implementations, determining the coefficient position with respect to the encoded portion of the video content can include determining a coefficient row value corresponding the coefficient position.

In some implementations, determining the coefficient position with respect to the encoded portion of the video content can include determining an x-coordinate corresponding the coefficient position.

In some implementations, determining the coefficient position with respect to the encoded portion of the video content can include determining a y-coordinate corresponding the coefficient position.

In some implementations, determining the side information can include determining that the encoded portion of the video content is encoded according to at least one of a discrete cosine transform (DCT) type, asymmetric discrete sine transform (ADST) type, discrete sine transform (DST) type, flipped DCT type, flipped DST type, or flipped DST type. Interpreting the one or more FCP syntax can include determining a sequentially last significant coefficient position of the encoded portion of the video content based on the one or more FCP syntax.

In some implementations, determining the side information can include determining that the encoded portion of the video content is encoded according to an identity transform type. Interpreting the one or more FCP syntax can include determining a sequentially first significant coefficient position of the encoded portion of the video content based on the one or more FCP syntax.

In another aspect, a method includes: accessing, by one or more processors, video content for encoding; generating, by the one or more processors, a bitstream representing the video content, where generating the bitstream includes: generating a first encoded portion of the video content, determining a coefficient position associated with the encoded portion of the video content, generating side information representing one or more characteristics of an encoded portion of portion of the video content, generating one or more flexible coefficient position (FCP) syntax based on the coefficient and the side information, where the one or more FCP syntax indicate one or more index values, and including first encoded portion of the video content, the one or more FCP syntax, and the side information in the bitstream.

In some implementations, the encoded portion of the video content can include at least one of a coding unit or a transform unit of the video content.

In some implementations, generating the one or more FCP syntax can include determining whether the one or more FCP syntax represent (i) a sequentially first significant coefficient position of the encoded portion of the video content or (ii) a sequentially last significant coefficient position of the encoded portion of the video content.

In some implementations, generating the one or more FCP syntax can include determining whether the encoded portion of the video content is encoded according to a forward coefficient scan order or a reverse coefficient scan order.

In some implementations, the one or more FCP syntax can indicate a single index value.

In some implementations, the one or more FCP syntax can indicate a plurality of index values.

In some implementations, generating the side information can include generating an indication of least one of: a transform type of the encoded portion of the video content, coding block dimensions of the encoded portion of the video content, a transform unit size of the encoded portion of the video content, a plane type of the encoded portion of the video content, a coding mode of the encoded portion of the video content, or information regarding one or more additional encoded portions of the video content neighboring the encoded portion of the video content.

In some implementations, generating the one or more FCP syntax can include determining a coefficient index value corresponding the coefficient position.

In some implementations, generating the one or more FCP syntax can include determining a coefficient column value corresponding the coefficient position.

In some implementations, generating the one or more FCP syntax can include determining a coefficient row value corresponding the coefficient position.

In some implementations, generating the one or more FCP syntax can include determining an x-coordinate corresponding the coefficient position.

In some implementations, generating the one or more FCP syntax can include determining a y-coordinate corresponding the coefficient position.

Other implementations are directed to systems, devices, and non-transitory, computer-readable media having instructions stored thereon, that when executed by one or more processors, causes the one or more processors to perform operations described herein.

The details of one or more embodiments are set forth in the accompanying drawings and the description below. Other features and advantages will be apparent from the description and drawings, and from the claims.

### BRIEF DESCRIPTION OF DRAWINGS

FIG. 1 is a diagram of an example system for encoding and decoding video content.

FIG. 2 is a diagram of example encoding and decoding operations.

FIG. 3 is a diagram of example partitioning of logical units of video content.

FIG. 4 is a diagram of an example signaling order of the syntax elements related to coefficient coding.

FIG. 5 is a diagram of example scan orders and context derivations.

FIG. 6 is a diagram of an example decoder for interpreting FCP syntax.

FIG. 7 is a diagram of another example decoder for interpreting FCP syntax.

FIGS. 8A and 8B are diagrams of example techniques for decoding a logical unit according to FCP syntax.

FIGS. 9A and 9B are diagrams of example techniques for decoding a logical unit according to FCP syntax.

FIGS. 10A-10D are diagrams showing example syntax designs.

FIG. 11 is a diagram of example variable coefficient groups.

FIG. 12A is a diagram of an example process for decoding video content.

FIG. 12B is a diagram of an example process for encoding video content.

FIG. 13 is a diagram of an example device architecture for implementing the features and processes described in reference to FIGS. 1-12.

### DETAILED DESCRIPTION

In general, computer systems can encode and decode video content. As an example, a first computer system can obtain video content (e.g., digital video including several frames or video pictures), encode the video content in a compressed data format (sometimes referred to as a video compression format), and provide the encoded data to a second computer system. The second computer system can decode the encoded data (e.g., by decompressing the compressed data format to obtain a representation of the video content). Further, the second computer system can generate a visual representation of the video content based on the decoded data (e.g., by presenting the video content on a display device).

In some implementations, encoders and decoders (codecs) can process video content according to a block-based technique. For instance, during an encoding process, an encoder can partition each of several logical units of video content into several smaller respective logical sub-units. In some implementations, each of the logical sub-units can be further partitioned into small respective logical sub-units (which in turn can be further partitioned one or more times). In some implementations, each of the coding blocks can include a particular number and arrangement of pixels of the original video frame (e.g., 4×4 pixels, or any other number or arrangement of pixels). In some implementations, these blocks or logical units may also be referred to as coding units (CU) or transform units (TU).

Further, codecs can process video content according to various transformation types. As an example, transformation types can include a discrete cosine transform (DCT), an asymmetric discrete sine transform (ADST), a flipped ADST, and an identity transform (IDTX). These transforms can be applied either in one dimension (1D) (e.g., horizontally or vertically) or in two dimensions (2D), such as both horizontally and vertically with 2D transform kernels. In some implementations, a secondary transform called “intra secondary transform” (IST) can be applied as a non-separable transform kernel on top of the primary transform coefficients based on a mode decision by the encoder.

Regardless of the transform type selected by an encoder, the resulting coefficients from the transform stage are signaled to the decoder (e.g., in a bitstream representing the video content), such that the decoder can accurately decode the encoded video content.

In some implementations, an encoder can signal to the decoder that certain coefficients should be parsed in order to accurately decode the encoded video content. As an example, an encoder can signal a first significant coefficient position for a particular logical unit. Based on this coefficient position signaling, the decoder can parse the coefficients for the logical unit in sequential order (also referred to as a forward scan), starting from the signaled first significant coefficient, and ending at the last coefficient location of the logical unit and/or after some other stop criteria have been satisfied. Further, the decoder can skip any coefficients that are sequentially prior to the signaled first significant coefficient (e.g., coefficients that are considered “insignificant” for reconstructing the video content).

As another example, an encoder can signal a last significant coefficient position for a particular logical unit. Based on this signaling, the decoder can parse the coefficients for the logical unit in reverse sequential order (also referred to as a reverse scan), starting from the signaled last significant coefficient, and ending at the first coefficient of the logical unit and/or after some other stop criteria have been satisfied. Further, the decoder can skip any coefficients that are sequentially after the signaled last significant coefficient (e.g., coefficients that are considered “insignificant” for reconstructing the video content).

In some implementations, an encoder can signal the position of a first significant coefficient and/or a last significant coefficient for logical unit according to a unified flexible coefficient position (FCP) syntax. The FCP syntax can indicate a particular value (e.g., a scalar value) that represents a position of a particular coefficient among a set of coefficient locations or coordinates. However, the FCP syntax need not expressly signal or indicate the meaning of that value (e.g., the FCP syntax need not expressly signal whether the value represents the first significant coefficient or the last significant coefficient). Instead, the FCP syntax can be interpreted based on contextual information regarding the video content, such as the transform type for a particular logical unit and/or any other information regarding the logical unit. In some implementations, this contextual information may also referred to as “side information.”

Upon receiving the encoded video content, a decoder can parse the FCP syntax from the encoded video content. Further, the decoder can determine contextual information regarding the video content (e.g., contextual information signaled by the encoder regarding a particular logical unit). Based on the contextual information, the decoder can interpret the meaning of the FCP syntax (e.g., by determining whether the signaled value represents a first significant coefficient and/or a last significant coefficient for the logical unit). In turn, the decoder can decode the encoded video content according to the signaled coefficient and according to the interpreted FCP syntax.

Implementations of the techniques described herein can be used in conjunction with various video coding specifications, such as H.264 (AVC), H.265 (HEVC), H.266 (VVC), AV1, and AVM, among others.

The systems and techniques described herein can provide various technical benefits. For example, the FCP syntax enables encoders and decoders to process video content according to a simplified and unified syntax, the meaning of which can be inferred based on contextual information rather than expressly signaled in a bitstream. Accordingly, these techniques can reduce the size and/or complexity of the encoded video content (e.g., compared to video content encoded without use of FCP signaling). Further, these techniques enable computer systems to reduce the amount of resources that are expended to encode, store, transmit, and decode video content. For instance, these techniques can reduce an expenditure of computational resources (e.g., CPU utilization), network resources (e.g., bandwidth utilization), memory resources, and/or storage resources by a computer system in encoding, storing, transmitting, and decoding video content.

For instance, in some implementations, the system and techniques described herein can provide throughput and complexity improvements, hardware simplifications, flexibility in signaling a significant coefficient position to use in different coefficient coding processes, Bjontegaard Delta-Rate (BD-rate) improvements, and a generalized design to replace the existing types of fixed-meaning position signaling (e.g., last position signaling) in image and video codecs.

As an illustrative example, the current AVM codebase, which will become a successor to the AV1 specification, was modified to include the FCP signaling techniques described herein. This modification enabled signaling a single and unified FCP syntax to indicate a first significant position (FP) index for the IDTX transform and a last significant position (LP) index for non-IDTX transforms. This enabled IDTX coded residuals to skip non-significant coefficients (e.g., zeros) before the first coded significant coefficient, which resulted in a throughput improvement around 4.7% for screen content sequences and around 1% improvement for natural content sequences compared to current AVM codebase in which only a fixed LP syntax is signaled. This saves decoding power and made the decoding process faster and easier for the hardware.

As another example, a unified FCP syntax can be used as an escape symbol to indicate different coefficient position meanings based on side information. Accordingly, no new or separate syntax is needed to transmit either the last position index or the first position index (e.g., only one syntax can cover both indices). This allows a simpler hardware design since introducing a new separate position syntax (instead of using the same unified design) would add around 9 separate syntax elements in AVM with syntax counts (5, 6, 7, 8, 9, 10, 11, 2) and add 28 context models with 224 CDF entries stored in RAM memory in AVM. The techniques described herein can avoid this hardware complication.

As another example, the techniques described herein can improve the BD-rate gain for coding block with an IDTX transform. For instance, in an example study, these techniques added around 0.21% overall BD-rate gain for random access (on both natural and screen-content sequences) and 0.31% BD-rate gain for random access for screen-content sequences over the current AVM codebase. This largely improved the BD-rate efficiency of blocks encoded according to the Forward Skip Coding (FSC) technique (e.g., as described in U.S. application Ser. No. 18/076,166, which is incorporated herein by reference in its entirety). Although example improvements are described herein, in practice, the improvements may differ depending on the implementation.

As another example, the techniques described herein can be used to signal a particular coefficient in a flexible manner (e.g., whereby the meaning of the signaling may have different meanings depending on contextual information), rather than using signaling having a fixed meaning. Accordingly, the signaling can be used in a wider variety of contexts and use cases than might otherwise be possible using fixed meaning signaling.

### General Overview

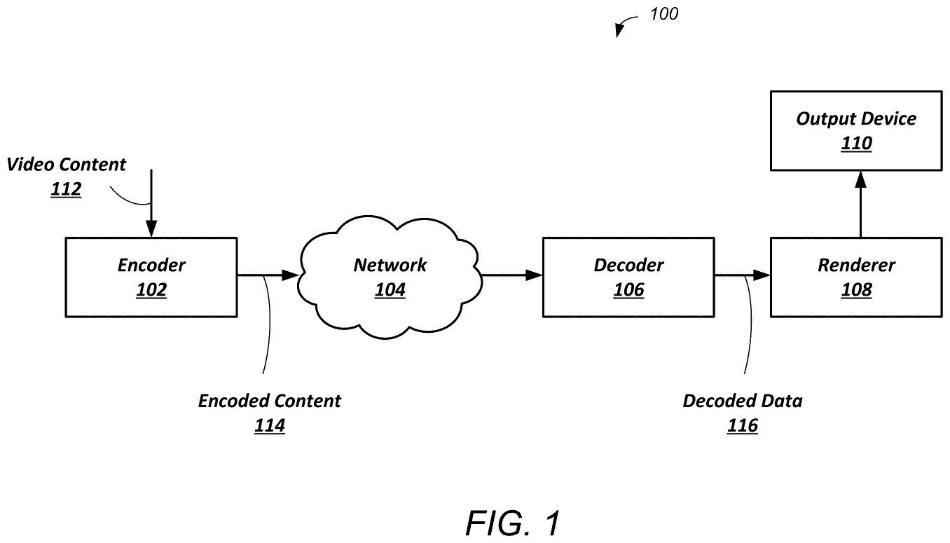

FIG. 1 is a diagram of an example system 100 for processing and displaying video content. The system 100 includes an encoder 102, a network 104, a decoder 106, a renderer 108, and an output device 110.

During an example operation of the system 100, the encoder 102 receives information regarding video content 112. As an example, the video content 112 can include an electronic representation of moving visual images, such as a series of digital images that are displayed in succession. In some implementations, each of the images may be referred to as frames or video pictures.

The encoder 102 generates encoded content 114 based on the video content 112. The encoded content 114 includes information representing the characteristics of the video content 112, and enables computer systems (e.g., the system 100 or another system) to recreate the video content 112 or approximation thereof. As an example, the encoded content 114 can include one or more data streams (e.g., bit streams) that indicate the contents of each of the frames of the video content 112 and the relationship between the frames and/or portions thereof.

The encoded content 114 is provided to a decoder 106 for processing. In some implementations, the encoded content 114 can be transmitted to the decoder 106 via a network 104. The network 104 can be any communications networks through which data can be transferred and shared. For example, the network 104 can be a local area network (LAN) or a wide-area network (WAN), such as the Internet. The network 104 can be implemented using various networking interfaces, for instance wireless networking interfaces (e.g., Wi-Fi, Bluetooth, or infrared) or wired networking interfaces (e.g., Ethernet or serial connection). The network 104 also can include combinations of more than one network, and can be implemented using one or more networking interfaces.

The decoder 106 receives the encoded content 114, and extracts information regarding the video content 112 included in the encoded content 114 (e.g., in the form of decoded data 116). For example, the decoder 106 can extract information regarding the content of each of the frames of the video content 112 and the relationship between the frames and/or portions thereof.

The decoder 106 provides the decoded data 116 to the renderer 108. The renderer 108 renders content based on the decoded data 116, and presents the rendered content to a user using the output device 110. As an example, if the output device 110 is configured to present content according to two dimensions (e.g., using a flat panel display, such as a liquid crystal display or a light emitting diode display), the renderer 108 can render the content according to two dimensions and according to a particular perspective, and instruct the output device 110 to display the content accordingly. As another example, if the output device 110 is configured to present content according to three dimensions (e.g., using a holographic display or a headset), the renderer 108 can render the content according to three dimensions and according to a particular perspective, and instruct the output device 110 to display the content accordingly.

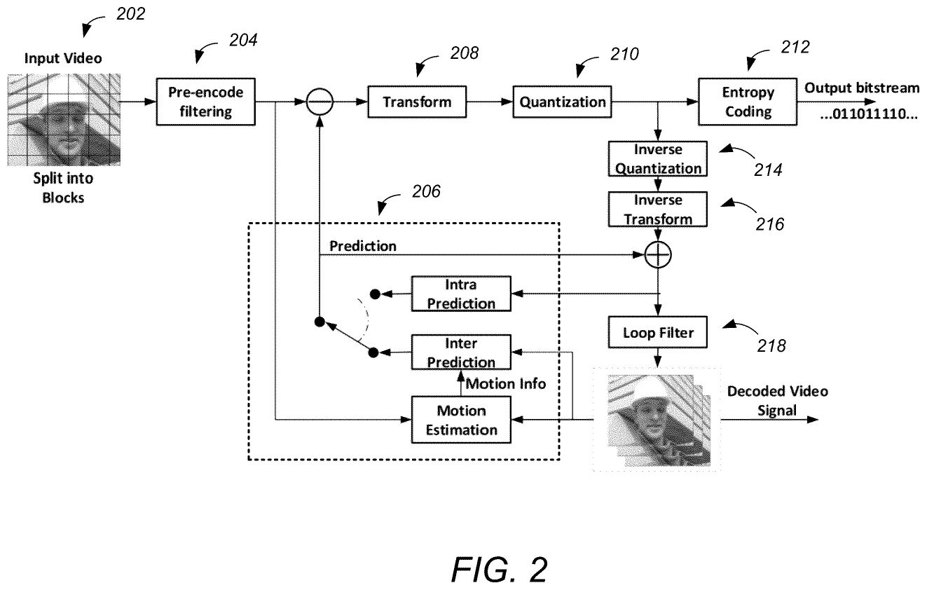

FIG. 2 shows an example encoding and decoding operations in greater detail.

As shown in FIG. 2, an encoder 102 receives input video (e.g., the video content 112), the splits or partitions the input video into several units or blocks (block 202). As an example each frame of the video content can be partitioned into a number of smaller regions (e.g., rectangular or square regions). In some implementations, each region can be further partitioned into a number of smaller sub-regions (e.g., rectangular or square sub-regions). In some implementations, a frame can be split into smaller coding-tree units (CTUs) or super-blocks (SBs). Further, a CTU or SB can further be divided into smaller coding blocks (CBs).

The encoder 102 can filter the video content according a pre-encoding filtering stage (block 204). As examples, the pre-encoding filtering stage can be used to remove spurious information from the video content and/or remove certain spectral components of the video content (e.g., to facilitate encoding of the video content). As further examples, the pre-encoding filtering stage can be used to remove interlacing form the video content, resize the video content, change a frame rate of the video content, and/or remove noise from the video content.

In a prediction stage (block 206), the encoder 102 predicts pixel samples of a current block from neighboring blocks (e.g., by using intra prediction tools) and/or from temporally different frames/blocks (e.g., using inter prediction/motion compensated prediction), or hybrid modes that use both inter and intra prediction. Other example prediction techniques include temporal interpolated prediction and weighted prediction.

In general, the prediction stage aims to reduce the spatial and/or temporally redundant information in coding blocks from neighboring samples or frames, respectively. The resulting block of information after subtracting the predicted values from the block of interest may be referred to as a residual block. The encoder 102 then applies a transformation on the residual block using variants of the discrete cosine transform (DCT), discrete sine transform (DST), or other possible transformation. The block on which a transform is applied is often referred to as a transform unit (TU).

Further, in a transform stage (block 208), the encoder 102 provides energy compaction in the residual block by mapping the residual values from the pixel domain to some alternative Euclidean space. This transformation aims to generally reduce the number of bits required for the coefficients that need to be encoded in the bitstream.

In some implementations, an encoder can skip the transform stage. For example, the transform stage can be skipped in cases when the residual signal after prediction is compact enough and if performing a transform does not yield additional compression benefits.

The resultant coefficients are quantized using a quantizer stage (block 210), which reduces the number of bits required to represent the transform coefficients. Further, optimization techniques such as trellis-based quantization or dropout optimization or coefficient thresholding can be performed to tune the quantized coefficients based on some rate-distortion criteria to reduce bitrate.

However, quantization can also cause loss of information, particularly at low bitrate constraints. In such cases, quantization may lead to a visible distortion or loss of information in images/video. The tradeoff between the rate (e.g., the amount of bits sent over a time period) and distortion can be controlled with a quantization parameter (QP).

In the entropy coding stage (block 212), the quantized transform coefficients, which usually make up the bulk of the final output bitstream, are signaled to the decoder using lossless entropy coding methods such as multi-symbol arithmetic coding or context-adaptive binary arithmetic coding (CABAC).

Further, certain encoder decisions can be signed to the decoder (e.g., by encoding context information in the bitstream). An example, this contextual information (also referred to as side information) can indicate partitioning types, intra and inter prediction modes (e.g., weighted intra prediction, multi-reference line modes, etc.), transform type applied to transform blocks, the position of the last coded coefficient in a TU and or other flags/indices pertaining to tools such as a secondary transform. The decoder can use this signaled information to perform an inverse transformation on the de-quantized coefficients and reconstruct the pixel samples

The output of the entropy coding stage is provided as the encoded content 114 (e.g., in the form of an output bitstream).

In general, the decoding process is performed to reverse the effects of the encoding process. As an example, an inverse quantization stage (block 214) can be used to reverse the quantization applied by the quantization stage. Further, an inverse transform stage (block 216) can be used to reverse the transformation applied by the transform stage to obtain the frames of the original video content (or approximations thereof).

Further, restoration and loop-filters (block 218) can be used on the reconstructed frames (e.g., after decompression) to further enhance the subjective quality of reconstructed frames. This stage can include de-blocking filters to remove boundary artifacts due to partitioning, and restoration filters to remove other artifacts, such as quantization and transform artifacts.

The output of the loop filter is provided as the decoded data 116 (e.g., in the form of video content, such as a sequence of images, frames, or video pictures).

### Transform Signaling

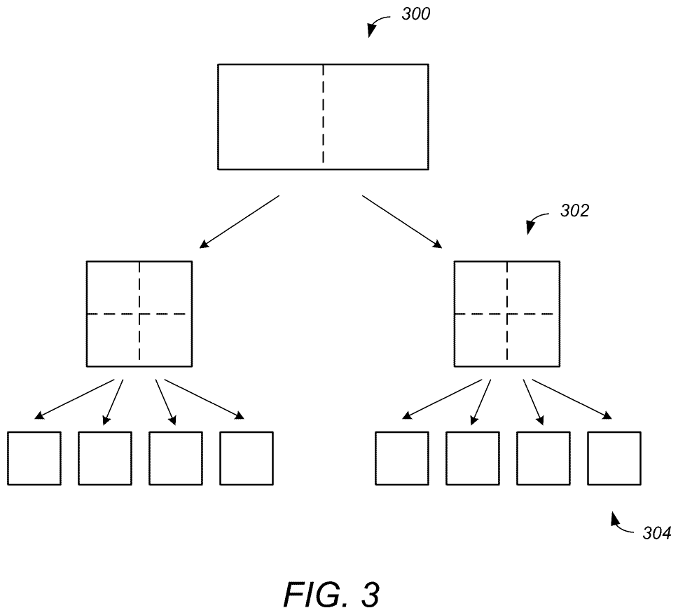

As described above, in general, encoders and decoders (codecs) can process video content according to a block-based technique. For instance, during an encoding process, an encoder can partition each of several logical units of video content into several smaller respective logical sub-units. In some implementations, each of the logical sub-units can be further partitioned into small respective logical sub-sub-units (which in turn can be further partitioned one or more times). As an example, as shown in FIG. 3, a video frame 300 can be partitioned into several smaller coding-tree units (CTUs) or superblocks 302. Further, CTUs or superblocks 302 can be partitioned into smaller respective coding blocks 304 for finer processing. In some implementations, each of the coding blocks can include a particular number and arrangement of pixels of the original video frame (e.g., 4×4 pixels, or any other number or arrangement of pixels)

Further, in general, codecs can process video content according to various transformation types. As an example, transformation types can include a discrete cosine transform (DCT), an asymmetric discrete sine transform (ADST), a flipped ADST, and an Identity transform (IDTX). These transforms can be applied either in one dimension (1D) (e.g., horizontally or vertically) or in two dimensions (2D), such as both horizontally and vertically with 2D transform kernels as summarized in Table 1 below. As a special case, the IDTX case skips a trigonometric/wavelet or other transform both vertically and horizontally.

TABLE 1
Example transform types.

| | Transform | Vertical | Horizontal |
|---|---|---|---|
| | Type | Mode | Mode |
| DCT_DCT | 2D | DCT | DCT |
| ADST_DCT | 2D | ADST | DCT |
| DCT_ADST | 2D | DCT | ADST |
| ADST_ADST | 2D | ADST | ADST |
| FLIPADST_DCT | 2D | Flipped ADST | DCT |
| DCT_FLIPADST | 2D | DCT | Flipped ADST |
| FLIPADST_FLIPADST | 2D | Flipped ADST | Flipped ADST |
| ADST_FLIPADST | 2D | ADST | Flipped ADST |
| FLIPADST_ADST | 2D | Flipped ADST | ADST |
| IDTX | 2D | Identity | Identity |
| V_DCT | 1D | DCT | Identity |
| H_DCT | 1D | Identity | DCT |
| V_ADST | 1D | ADST | Identity |
| H_ADST | 1D | Identity | ADST |
| V_FLIPADST | 1D | Flipped ADST | Identity |
| H_FLIPADST | 1D | Identity | Flipped ADST |

Once a suitable transform type is selected by the encoder, the selected transform type is then signaled to the decoder using different transform sets. In some implementations, such signaling can be performed at the TU level. Example transform sets are shown in Tables 2. For instance a discrete trigonometric transform set (DTT4) in AV1 contains 4 possible transform types where combinations of DCT and ADST may be used. The DTT4 set can be selected for intra coded blocks when the minimum of the height or width of a block is less than 8. As another example, the DTT set can be used for larger inter coded blocks. In general, various sets can be deigned to reduce the signaling overhead of different block types and sizes when a transform type needs to be signaled.

TABLE 2
Example transform sets.

| | Vertical | Horizontal | |
|---|---|---|---|
| | Mode | Mode | TX Set |
| DCT_DCT | DCT | DCT | DDT 4 Set |
| ADST_DCT | ADST | DCT | |
| DCT_ADST | DCT | ADST | |
| ADST_ADST | ADST | ADST | |
| FLIPADST_DCT | Flipped | DCT | DDT 9 Set (includes |
| | ADST | | DDT 4 above) |
| DCT_FLIPADST | DCT | Flipped ADST | |
| FLIPADST_FLIPADST | Flipped | Flipped ADST | |
| | ADST | | |
| ADST_FLIPADST | ADST | Flipped ADST | |
| FLIPADST_ADST | Flipped | ADST | |
| | ADST | | |
| IDTX | Identity | Identity | 1D DCT |
| V_DCT | DCT | Identity | |
| H_DCT | Identity | DCT | |
| V_ADST | ADST | Identity | |
| H_ADST | Identity | ADST | |
| V_FLIPADST | Flipped | Identity | |
| | ADST | | |
| H_FLIPADST | Identity | Flipped ADST | |

Table 3 shows which transform sets are used when signaling the transform type for intra and inter blocks. The signaled transform set depends on the minimum block width and height.

TABLE 3
Example uses of transform sets.

| min(W, H) | Intra | Inter |
|---|---|---|
| 4 | DTT4, 1DDCT | ALL 16 |
| 8 | DTT4, 1DDCT | ALL 16 |
| 16 | DTT4 | DTT9, IDTX, 1DDCT |
| 32 | DCT Only (no | DCT, IDTX |
| | signaling) | |
| 64 | DCT Only (no | DCT Only (no signaling) |
| | signaling) | |

In some implementations (e.g., in AVM), a secondary transform called “intra secondary transform” (IST) can be applied as a non-separable transform kernel on top of the primary transform coefficients to further compact these transform coefficients. However, in contrast to DCT-like transforms, the IST is data-driven and uses trained non-separable kernels. IST kernels can be selected based on intra modes, or can be decided by the encoder based on a variety of criteria, such as rate-distortion or rate-distortion-complexity criteria, and signaled to the decoder side.

In some implementations (e.g., in AVM), transform sets for intra coded TUs can be constructed based on a variety of other side information including syntax elements such as the intra coding mode used and other block level information.

In some implementations (e.g., in AVM), a flexible or forward skip coding (FSC) mode can be used. In FSC mode, a high-level skip decision to code residual samples is performed and signaled at the CU level. This mode signaling can be tied to a specific residual coding scheme, a transform type, and other inference rules that could be determined at the CU level.

### Coefficient Coding

Regardless of the transform type selected by an encoder, the resulting coefficients from the transform stage or the prediction residuals are signaled to the decoder.

In some implementations (e.g., AV1/AVM), coefficient coding can be summarized in 3 parts: 1) coding of the all_zero flag and transform types, 2) signaling of the last coefficient position or the end-of-the block (EOB) syntax, and 3) coefficient coding to transmit absolute values and signs of each coefficient sample.

### All Zero Flag and Transform Types:

In some implementations, an encoder first determines the position of the last significant coefficient in a TU for a given scan order. This last coefficient position can also be referred to as an end-of-block (EOB) position.

If the EOB value is 0, then the present TU does not have any significant coefficients and nothing else needs to be coded for the current TU. Therefore, the coefficient coding process can be terminated for the current TU. In this case, a TU skip flag (e.g., all_zero syntax in AV1) can be signaled to indicate whether the EOB is 0.

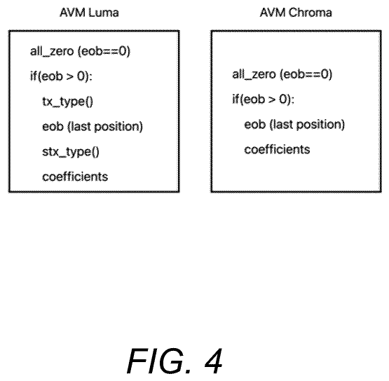

This is also shown in FIG. 4, which illustrates the signaling order of the syntax elements related to coefficient coding. As shown in FIG. 4, if the EOB value is non-zero (eob>0) for a given TU, then a transform type is coded only for luma blocks. Transform type is not coded for chroma blocks but is rather inferred from the co-located luma block or the current block's intra mode depending on whether the TU is an intra or inter coded block. Additionally, an IST flag and the kernel type (e.g., stx_type) can be signaled based on the primary transform type.

### Last Coefficient Position or End-of-the-Block (EOB) Syntax:

In some implementations, the last coefficient position or an EOB syntax can explicitly coded after the all_zero syntax element. This EOB value determines which coefficient indices to skip during coefficient coding and decoding.

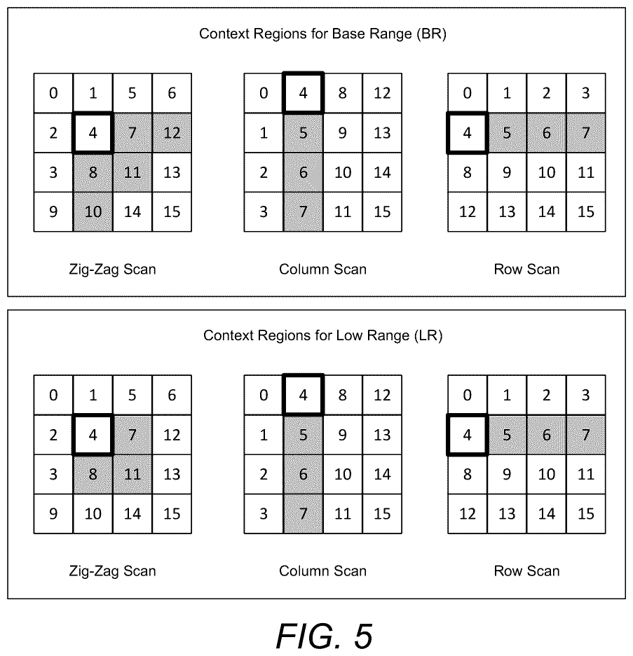

For example, FIG. 5 shows an example 4×4 TUs. If EOB=5, then only coefficients at indices 0, 1, 2, 3, and 4 are parsed and decoded. Other coefficient indices (e.g., >5) are not considered during the coefficient coding stage since coefficient values after EOB=5 are zero.

In some implementations, the EOB value can be signaled using multi-symbol syntax elements after binarizing the EOB index value. If the value is sufficiently large (e.g., greater than a particular threshold value), bypass coding (non-arithmetic) can be further used. In some implementations, CABAC can be used to signal the row and column indices associated with the EOB value (e.g., last_x and last_y) in a given TU after binarizing the x- and y-locations of the last significant coefficient position.

In some implementations, FSC mode can be performed at the CU level. In this case, all EOB signaling can be skipped for subsequent TUs coded in FSC mode.

In some implementations, EOB syntax can be signaled using different syntax elements depending on the block size. These syntax elements are responsible for transmitting a value in the range of [1, 1024]. This is because the largest non-zero region of any TU can contain coefficient indices up to 1024 (for a TU size of 32×32 or a TU size of 64×64 with zero-out regions defined in all except in the first 32×32 region). Given that the allowed range for coefficient indices is large, a combination of context coding of up to 11 symbols for the largest transform unit sizes of 32×32/64×64.

### Coefficient Coding:

In general, if an index of a coefficient is less than the EOB value, the coefficient is parsed during the coefficient coding stage. Coefficients are coded in multiple passes. These passes parse each coefficient based on a given scan order, such as the zig-zag, row, column, or diagonal scans. Each coefficient in a TU can be first converted into a “level” value by taking its absolute value.

For square blocks with a 2D transform, a reverse zig-zag scan can be used to encode the level information. In the example shown in FIG. 4, a zig-zag scan starts from the bottom right side of the TU in a coding loop from coefficient location 15, and proceeds in reverse sequential order until the coefficient location 0. In cases where the EOB value is less than 15, the level coding can start from the EOB value and loop (e.g., in reverse sequential order) until the coefficient location 0.

Other example scan orders (e.g., column scan and row scan) are also shown in FIG. 5.

In general, the level values can be signaled to the decoder in multiple passes as follows:
Base Range (BR): This covers level values of 0, 1, 2, and 3. If a level value is less than 3, consequently the level coding loop terminates here and coefficient coding does not visit the Low/High ranges (e.g., as discussed below). A value of 3 indicates that the level value can be equal or greater than 3 for BR pass. The level values are context coded depending on the neighboring level values and other parameters such as the transform size, plane type, etc.
Low Range (LR): This range covers level values between [3-14]. The level values are context coded depending on the neighboring level values and other parameters, such as transform size, plane type, etc.
High Range (HR): This range corresponds to level values greater than 15. The level information beyond 15 is Exp-Golomb coded without using contexts.

After level values are coded in a reverse scan order, the sign information can be coded separately using a forward scan pass over the significant coefficients. The sign flag can be bypass coded with 1 bit per coefficient without using probability models. In some implementations, this technique can simplify entropy coding, as DCT coefficients often have random signs.

In some implementations (e.g., AV1), level information can be encoded with a proper selection of contexts or probability models using multi-symbol arithmetic encoding. These contexts can be selected based on various information such as the transform size, color plane (luma or chroma) information, and the sum of previously coded level values in a spatial neighborhood.

FIG. 5 shows several examples of how the contexts can be derived based on neighboring level values. For instance, for base range coding with the zig-zag scan, the level value for scan index #4 can be encoded by using the level values in the shaded neighborhood (7, 8, 10, 11, 12). The level values in this neighborhood are summed together to select an appropriate probability model or a context index for arithmetic coding. The shaded blocks are already decoded, as the level information is decoded in a reverse scan order. Likewise, 1D transforms can only access the previously decoded 3 neighboring samples. Low Range coding constrains the context derivation neighborhood for 2D transforms to be within a 2×2 region.

In some implementations, a flexible coefficient coding scheme can define different context derivation rules, entropy models, and cumulative distribution functions (CDFs) based on the relative location and grouping of individual coefficient indices.

### Flexible Coefficient Position Signaling

In general, an encoder can signal the position of a first significant coefficient and/or a last significant coefficient for logical unit according to a unified flexible coefficient position (FCP) syntax. The FCP syntax can indicate a particular value (e.g., a scalar value) that represents a position of a particular coefficient among a set of coefficient locations. However, the FCP syntax need not expressly signal the meaning of that value (e.g., the FCP syntax need not expressly signal whether the value represents the first significant coefficient or the last significant coefficient). Instead, the FCP syntax can be interpreted based on contextual information regarding the video content, such as the transform type for a particular logical unit and/or any other information regarding the logical unit. In some implementations, this contextual information may also referred to as “side information.”

Upon receiving the encoded video content, a decoder can parse the FCP syntax from the encoded video content. Further, the decoder can determine contextual information regarding the video content (e.g., contextual information signaled by the encoder regarding a particular logical unit). Based on the contextual information, the decoder can interpret the meaning of the FCP syntax (e.g., by determining whether the signaled value represents a first significant coefficient and/or a last significant coefficient for the logical unit). In turn, the decoder can decode the encoded video content according to the signaled coefficient.

Although the description herein primarily discusses the use of the FCP syntax to signal the first significant coefficient or the last significant coefficient, in practice, the FCP syntax can be used to signal arbitrary coefficient locations in a logical unit (e.g., in a coding block or transform unit) in any use case or context.

In general, in existing image and video coding standards (e.g., AV1), a last coefficient position (LP) syntax can be included in the bitstream for each coding block to indicate the location of the last coded significant coefficient. The coefficient coding process in image and video codecs use the LP syntax to decide which coefficients to transmit in the bitstream and which ones to avoid signaling to the decoder to improve throughput and BD-rate gains. This LP syntax typically has a fixed “last position” meaning and does not require a contextual interpretation to be made by the decoder.

This LP syntax can be replaced and generalized using the FCP syntax described herein. The FCP syntax, unlike the LP syntax, behaves as an escape symbol and invokes an alternative interpretation at the decoder depending on contextual information regarding the video content (also referred to as side information). In some implementations, the FCP syntax can include (i) an expression identifying the FCP syntax, and (ii) a signaled value. As an illustrative example, the FCP syntax can be “fcp(N)”, where N is the signaled value.

The side information can be transform type, block size, plane type, intra and inter coding mode, as well as other coding decisions and statistics available to the decoder.

Depending on the interpreted meaning of the FCP syntax, various coefficient coding and decoding decisions and other encoding/decoding operations can be performed for a coding block. For instance, a separate residual coding or coefficient coding method may be performed based on the interpretation of the FCP syntax.

The FCP syntax does not necessarily indicate a fixed meaning for a coefficient position (such as last coefficient position) in a coding block or TU. Instead, the FCP syntax can carry alternative meanings and can correspond to different coefficient locations given different side information.

For instance, an FCP syntax may be signaled from the encoder to the decoder along with other side information such as a transform type. The decoder can then interpret the meaning of the FCP syntax given the transform type. As an example, if the transform type is the 2D identity transform or a transform skip mode, the FCP syntax may mean the first significant position (FP) in a coding block. As another example, if the transform type is the 2D DCT, the FCP syntax may mean the LP.

Further, if the FCP syntax has a LP interpretation, a residual decoding approach may decode only the coefficients before the last significant position until the block beginning similar to current AVM. Alternatively, if the FCP syntax has a FP interpretation, then a residual decoding method such as a skip residual coding scheme can decode the coefficients after the first significant coefficient position until the end-of-block. These different operations may or may not use different coefficient scan directions or orders.

To simplify FCP syntax design and signaling, a unified FCP syntax can be used where the same entropy coding rules, entropy models, and cumulative distribution functions can be used when transmitting the FCP value from encoder to the decoder side regardless of the signaled value.

Further, the FPC syntax can be to indicate arbitrary coefficient position of interest and an associated meaning at the decoder using side information.

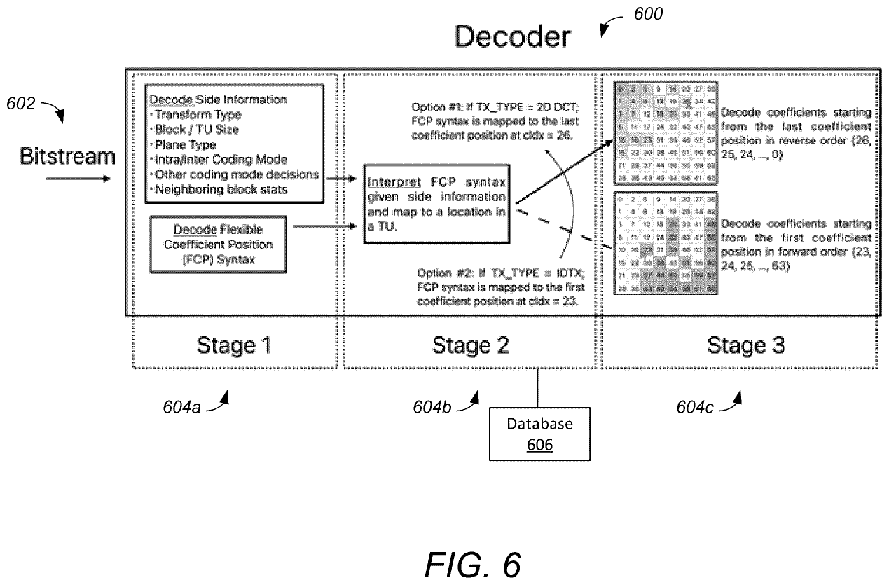

FIG. 6 shows an example decoder 600 for processing encoded video content. During an example operation, the decoder 600 accesses a bitstream 602 representing encoded video content, and decodes at least a portion of the bitstream 602 to reconstruct the video content.

The decoder 600 includes three stages or modules 604a-604c for interpreting FCP syntax included in the bitstream 602. In general, the stages 604a-604c can be implemented using hardware, software, firmware, or a combination thereof. Although FIG. 6 shows the stages 604a-604c as separate components, in practice, some or all of the stages 604a-604c can be implemented as a single component (e.g., a single instance of hardware, software, and/or firmware) or as individual components (e.g., individual instances of hardware, software, and/or firmware).

During operation of the decoder 600, the stage 604a (“Stage 1”) parses the bitstream 602, and decodes (or otherwise derives) information pertaining to the interpretation of FCP syntax signaled in the bitstream 602.

In particular, Stage 1 decodes one or more FCP syntax signaled in the bitstream 602. In some implementations, the FCP syntax indicate one or more values (e.g., a scalar value). Further, the FCP syntax does not expressly indicate the meaning of the value (e.g., the FCP syntax need not expressly signal whether the value represents the first significant coefficient or the last significant coefficient of a logical unit).

Further, Stage 1 decodes side information signaled in the bitstream 602. Side information includes any context information regarding the encoded video content of the bitstream 602. As an example, the side information can include information such as the transform type of a logical unit (e.g., a coding block or transform unit), dimensions of the logical unit (e.g., coding block dimensions), a size of the logical unit (e.g., a transform unit size), and/or a plane type pf the logical unit. As another example, the side information can include information regarding various coding mode decisions made by the encoder when generating the encoded video content, such as the intra and/or inter coding modes that were used by the encoder to encode the video content. As another example, the side information can information or statistics of neighboring logical units (e.g., coding modes of those logical units and/or any other information regarding those logical units, as described above).

In some implementations, Stage 1 can additionally process and/or perform arithmetic operations with respect to the value indicated by the FCP syntax (e.g., to derive a new value based on the value indicated by the FCP syntax). In some implementations, the new value can represent a scalar value. In some implementations, the new value can represent some other type of value.

The stage 604b (“Stage 2”) interprets the FCP syntax based on the decoded side information. For example, Stage 2 can access a database 606 (e.g., data records, data table, etc.) that maps (i) specific combinations of side information to (ii) a corresponding meaning of the FCP syntax in that context. The decoder can determine that a particular combination of side information is signaled in the bitstream 602, determine the meaning of the FCP syntax in that context, and interpret the FCP syntax accordingly. For instance, the database 606 may indicate that there are N possible meanings of the FCP syntax (and correspondingly, N different ways of interpreting the FCP syntax), depending on the combination of side information signaled in the bitstream 602. Stage 2 can select one of those meanings (and interpret the FCP syntax according to that meaning), based on the particular side information signaled in the bitstream 602.

Two example interpretations are shown in FIG. 6.

According to a first example (“Option #1”), if the decoded transform type (TX_TYPE) is a 2D DCT transform, Stage 2 interprets the value indicated by the FCP syntax as the end-of-block (EOB) or last position, and maps the indicated value to a coefficient position of 26.

According to a second example (“Option #2), if the TX_TYPE is a 2D identity transform (IDTX), Stage 2 interprets the value indicated by the FCP syntax as the beginning-of-block (BOB) or the first significant coefficient position in a logical unit. Further, the value is mapped to a coefficient position of 23=26−X, where X is a scalar and value is determined by side information as X=3, according to a generic scan order.

Note that the final mapping to a value can also depend on side information and can be same or different between different options. For example, a FCP syntax indicating a particular value may be mapped to a first final value given certain side information, but may be mapped to a second different final value given certain other side information.

Stage 604c (“Stage 3”) decodes and reconstructs transform coefficients indicated in the bitstream 602 (e.g., using a suitable residual coding method) based on the interpretation of the FCP syntax by Stage 2.

For instance, according to the first example (“Option #1”), the side information for a logical unit indicates that the TX_TYPE is 2D DCT. Based on this side information, Stage 2 interprets the value indicated by the FCP syntax as the EOB. Based on this interpretation, Stage 3 decodes the coefficients for the logical unit in a reverse diagonal scan order starting from a EOB=26, and continue decoding coefficients in reverse sequentially consecutive locations {26, 25, 24, 23, . . . , 0}. This enables the encoder to skip transmitting any coefficient level information if the coefficient index is greater than 26 in reverse scan order.

Further, according to the second example (“Option #2”), the side information for a logical unit indicates that the TX_TYPE is IDTX. Based on this side information, Stage 2 interprets the value indicated by the FCP syntax as the BOB. Based on this interpretation, Stage 3 decodes the coefficients for the logical unit in a forward diagonal scan order starting from a EOB=23, and continue decoding coefficients in sequentially consecutive locations {23, 24, 25, 26, . . . , 63}. This enables the encoder to skip transmitting any coefficient level information if the coefficient index is less than 23 in a forward scan order.

In the example shown in FIG. 6, a decoder 600 parses and interprets a single FCP syntax to decode a single logical unit (e.g., a single coding block or transform unit). However, some implementations, a decoder can parse and interpret multiple FCP syntax to decode a single logical unit.

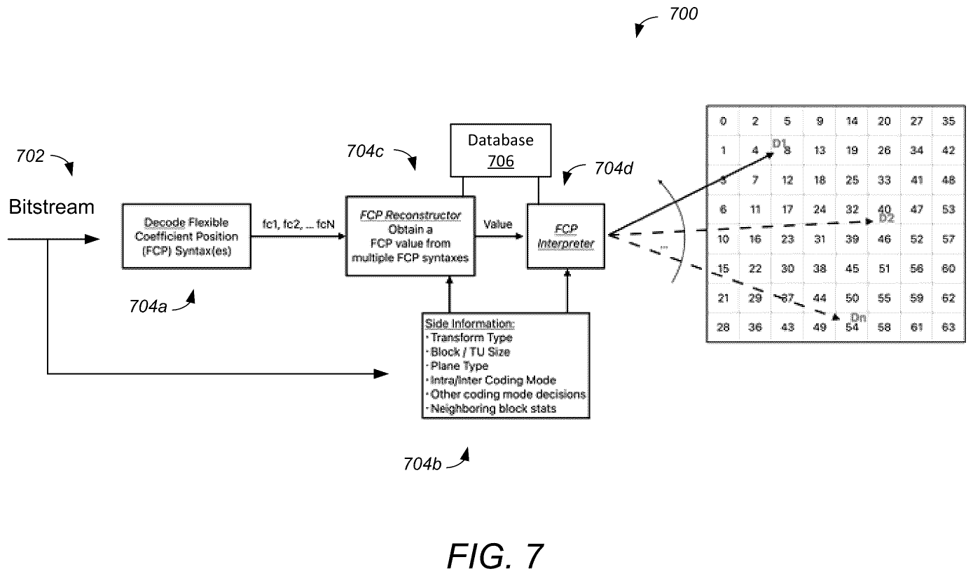

For instance, FIG. 7 an alternative implementation 700 of the Stages 1 and 2 shown in FIG. 6.

In this example, a decoder module 704a accesses a bitstream 702 representing encoding video content, and decodes multiple FCP syntaxes signaled in the bitstream 702. For example, the decoder module 704a can decode multiple values indicated by the FCP syntaxes (e.g., fc1, fc2, . . . , fcN). Further, the FCP syntaxes do not expressly indicate the meaning of the values (e.g., the FCP syntaxes need not expressly signal whether the values represent the first significant coefficient or the last significant coefficient of a logical unit).

Further, a decoder module 704b accesses the bitstream 702, and decodes side information signaled in the bitstream 702. As described above, side information includes any context information regarding the encoded video content of the bitstream 702. As an example, the side information can include information such as the transform type of a logical unit (e.g., a coding block or transform unit), dimensions of the logical unit (e.g., coding block dimensions), a size of the logical unit (e.g., a transform unit size), and/or a plane type pf the logical unit. As another example, the side information can include information regarding various coding mode decisions made by the encoder when generating the encoded video content, such as the intra and/or inter coding modes that were used by the encoder to encode the video content. As another example, the side information can information or statistics of neighboring logical units (e.g., coding modes of those logical units and/or any other information regarding those logical units, as described above).

A FCP reconstructor module 704c reconstructs a single FCP value based on the decoded FCP syntaxes and the decoded side information. As an example, the FCP reconstructor module 704 can reconstruct a single scalar X value from multiple FCP syntaxes, based on a certain combination of side information (e.g., side information indicating that the transform type is the 2D DCT or 2D ADST transforms). As another example, the FCP reconstructor module 704 can form a single scalar Y from multiple FCP syntaxes, based on certain other combinations of side information (e.g., side information indicating that the transform type is IDTX).

In some implementations, the reconstructed scalar X can indicate the last significant coefficient location in a logical unit (e.g., a coding block or a transform unit) or the EOB value. In some implementations, a reconstructed scalar Y can indicate the first significant coefficient position in a logical unit.

In some implementations, functions or mappings can be used to obtain other scalar values, based on a particular input. For example, a reconstructed scalar or FCP value Z can be passed through arithmetic operation(s), logical operation(s), and/or functions f1 or f2, such that Y=f1 (Z) or X=f2(Z), where operations f1 and f2 are defined (and can vary) based on side information such as block size, transform type, coding mode decisions, etc. Accordingly, a decoded FCP syntax and a value can be mapped to other scalars based on side information.

A FCP interpreter module 704d interprets the reconstructed FCP value. For example, based on the reconstructed FCP value and the decoded side information, the FCP interpreter module 704d identifies a particular coefficient (or group of coefficients) corresponding to the reconstructed FCP value.

The identified coefficient is provided to Stage 3 of the decoder 600 to facilitate the decoding of the video content. For example, as described with reference to FIG. 6, Stage 3 decodes and reconstructs transform coefficients indicated in the bitstream 602 (e.g., using a suitable residual coding method) based on the interpretation of the FCP syntax by the FCP interpreter 704d.

In some implementations, a reconstructed FCP value can correspond to one of the coefficient locations inside a logical unit (e.g., a coding unit or transform unit). For instance, as shown in FIG. 7, for an 8×8 TU size, there are 64 coefficient locations possible (e.g., [0, 1, . . . , 63]). The reconstructed FCP value, or any of the FCP value mappings, can correspond to a location in a given coding block or TU. The FCP interpreter module 704d interprets the FCP value based on side information, and maps the FCP value to one or several locations depending on the side information (e.g., D1, D2 and Dn). That is, it is possible to map the same FPC value to different locations, depending on the particular combination of side information decoded from the bitstream 702.

In some implementations, the FCP reconstructor module 704c can reconstruct a FCP value differently, depending on the decoded side information. As an example, if the transform type is IDTX, the FCP reconstructor module 704c can use only one FCP syntax (e.g., {f1}), and omit the other FCP syntaxes (e.g., {fc2, . . . , fcN}) during the reconstruction process. As another example, if the transform type is 2D DCT, the FCP reconstructor module 704c can use all of the FCP syntax elements during the reconstruction process. Note that signaling of FCP syntax may be constrained at the encoder side depending also on side information, such that the decoder only decodes a subset of FCP related syntaxes (e.g., {fcs2, fcs4}) and not the entire syntax set.

In some implementations, a FCP syntax can correspond to multiple coefficient locations in a logical unit (e.g., a coding blocking or a transform unit). As an example, a FCP syntax can include two syntax elements (s1 and s2), where s1 corresponds to the first non-zero coefficient position, and s2 indicates the last non-zero coefficient position. Further, the meaning of s1 and s2 can change, depending on whether the block uses transform skip (IDTX) or FSC. For example, if a block is encoded according to a FSC codec, the (s1,s2) syntax pair may indicate (first position, last position) of the coefficient. In contrast, for non-FSC blocks (s1,s2), may indicate (last position, first position) of the coefficient.

In some implementations, the FCP reconstructor module 704c and/or the FCP interpreter 704d can access a database 706 (e.g., data records, data table, etc.) that maps (i) specific combinations of side information to (ii) a corresponding technique for constructing a FCP value and/or a interpreting a FCP value in that context. A decoder can determine that a particular combination of side information is signaled in the bitstream 702, determine a corresponding technique for reconstructing a FCP value and/or a interpreting a FCP value in that context, and interpret the FCP syntaxes accordingly. For instance, the database 706 may indicate that there are N possible reconstruction and/or interpretation techniques, depending on the combination of side information signaled in the bitstream 702. The e FCP reconstructor module 704c and/or the FCP interpreter 704d can select one of those techniques, based on the particular side information signaled in the bitstream 702.

In some implementations, the techniques described herein can replace and generalize the EOB syntax signaling defined in AV1/AVM. For instance, in the AV1 draft text and AVM code, multiple FCP related syntaxes can be defined to replace existing syntax elements cob_pt_16, cob_pt_32, cob_pt_64, cob_pt_128, cob_pt_256, cob_pt_512, cob_pt_1024, cob_extra, cob_extra_bit with the same or alternative binarizations to transmit an arbitrary coefficient location. FCP syntaxes can also replace the last position signaling logic used in HEVC (H.265), and VVC (H.266). For example, in the VVC draft text, relevant FCP syntaxes can replace the existing last position syntax elements: last_sig_coeff_x_prefix, last_sig_coeff_y_prefix, last_sig_coeff_x_suffix, last_sig_coeff_y_suffix.

In some implementations, in the VVC specification and/or draft text, the last position related syntax elements: last_sig_coeff_x_prefix, last_sig_coeff_y_prefix, last_sig_coeff_x_suffix, last_sig_coeff_y_suffix with alternative FCP syntaxes fcp_sig_coeff_x_prefix, fcp_sig_coeff_y_prefix, fcp_sig_coeff_x_suffix, fcp_sig_coeff_y_suffix. The same binarization can be used to transmit the FCP location as if last x and y coordinates were being transmitted.

In some implementations, the FCP syntax can indicate only a row or column index for a given TU (e.g., similar to H.266, where last coefficient position is coded in row and column coordinates, such as lastX (last_sig_coeff_x_prefix, last_sig_coeff_x_suffix) and lastY (last_sig_coeff_y_prefix, last_sig_coeff_y_suffix)).

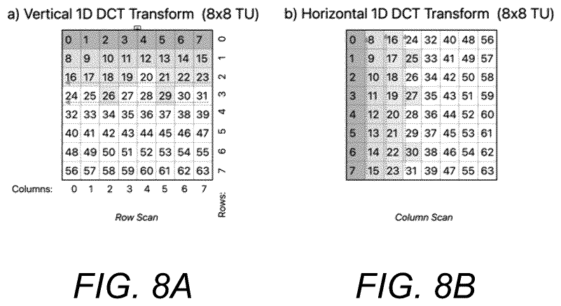

This example implementation is illustrated in FIGS. 8A and 8B, in which a vertical 1D DCT transform is applied using a reverse row scan (FIG. 8A), and a horizontal 1D DCT using a reverse column scan (FIG. 8B). The FCP syntax can include two syntax elements {fc1, fc2}, where fc1 syntax is equivalent to row index (lastY) of a significant FCP location, and fc2 syntax is equivalent to the column index (lastX) of the same FCP location. In the example shown in FIG. 8A, a column index can be omitted in signaling and fc2 can inferred to be the end of the max column size (e.g., if column width is 8 then fc2=7). Only a row index is transmitted as fc=3, which corresponds contains all coefficients numbered {24, 25, 26, . . . , 31}. The decoder can decode all the samples starting from row 3, row 2, row 1 and row 0, assuming all the samples need to be decoded.

In some implementations, an encoder can use different or multiple alternative coefficient coding approaches. For instance, in the AVM code base, the forward skip coding mode (FSC) mode uses a separate coefficient coding process to code coefficient values after the transform stage or a skip coding decision, whereas other transforms, such as the DCT or ADST, can use another coefficient coding process. It may be preferable for these two coefficient coding methods to start processing samples at different locations. For instance, it may be preferable for one residual coding method to start coding and decoding from the EOB location to the beginning of a block. Alternatively it may be preferable for a different residual coding method (e.g., a method used for forward skip coding) to code and/or decode samples starting from the first significant coefficient location or BOB location and process samples until the end of the block.

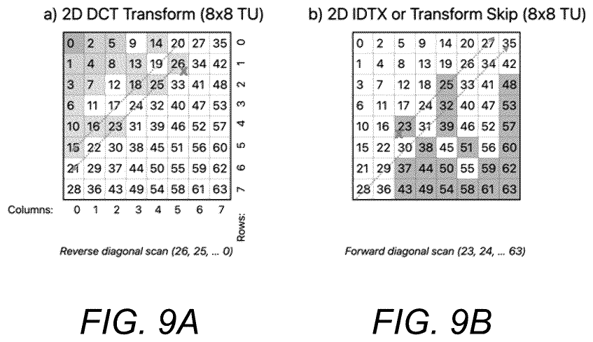

FIGS. 9A and 9B show an example of this case. In particular, FIG. 9A shows one residual coding method that uses a reverse diagonal scan. The significant coefficients that need to be coded and decoded are indicated with shaded boxes. The decoding in FIG. 9A starts from the last significant coefficient or the EOB value=26 (marked with an X) and proceeds decoding values {26, 25, 24, . . . , 0}.

FIG. 9B shows a different residual coding scheme where coefficients are coded and decoded using a forward diagonal scan (e.g., as in FSC mode in AVM). Here, it is beneficial for the encoder to skip the first portion of the block, since most coefficients in the beginning of a block are zero. In this case, the decoding in FIG. 9B starts from the first significant coefficient or the BOB value=26 (marked with an X) and proceeds decoding values {23, 24, 25, . . . , 63}.

In some implementations, the same entropy coding models, cumulative distribution functions (CDF), and CDF contexts can be used to encode the FCP value. These rules and models can be the same regardless of any other side information. For instance, a FCP value can be binarized using the same logic and coded with FCP syntaxes and entropy models when the transform type is DCT or IDTX.

In some implementations, a unified syntax design may not be desirable. Further, there may be flexibility in using multiple and different FCP syntaxes for each decision at the cost of hardware complexity. In these implementations, based on side information, separate FCP syntaxes can be used and different binarizations can be performed for the FCP syntax. As an example, if the transform type is IDTX, a separate FCP syntax, separate CDFs, and binarizations can be used to transmit an FCP value (which may indicate the BOB value). As another example, if the transform type is 2D DCT or 2D ADST, other FCP syntax, separate CDFs, and binarizations can be used to transmit an FCP value (which may indicate the EOB value).

In some implementations, the syntax design to transmit an FCP value can be binarized as in VVC (H.266). For instance, the same last position signaling rules and binarizations can be used as in VVC to transmit the FCP value. In these implementations, the FCP value can be transmitted as row and column indices separately.

In some implementations, the syntax design to transmit an FCP value can be binarized as in AVM. Depending on the block size, a different syntax element of variable symbol size can be used to indicate a 2D position index inside a logical unit (e.g., a coding block or a transform unit).

In some implementations, the FCP syntax can be signaled to the decoder prior to signaling a transform type (TX_TYPE). In these implementations, the decoder first decodes a transform type, and then decodes the FCP syntax or a location that will be interpreted based on the previously decoded transform type.

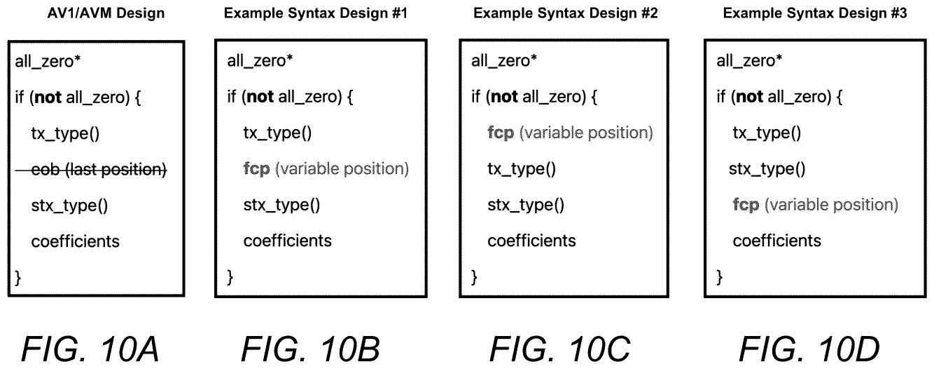

In some implementations, the FCP syntax can be signaled at any point before decoding coefficients (e.g., as shown in FIGS. 10A-10D). This is because interpretation of the FCP syntax can be performed immediately prior to the FCP syntax being used by the decoder for decoding other syntax. For instance, as shown in FIG. 10B, a decoder can decode the FCP index after the all_zero syntax but before all other transform type related syntaxes. The decoder can retain this value until the coefficient decoding stage and can interpret that FCP corresponds to a specific location prior to decoding coefficients.

In some implementations, the FCP syntax can be signaled to the decoder prior to signaling a secondary transform type, such as Intra Secondary Transform (IST) in AVM or Low-frequency non-separable transform (LFNST) in VVC (H.266).

In some implementations, if a secondary transform is used in a video codecs such as LFNST in VVC or IST in AVM, then the FCP interpreter can decide that there could be a zero-out of high-frequency coefficients. Therefore, an FCP value can only correspond to a position inside the allowed secondary transform zone. In these implementations, given a non-zero secondary transform index or flag, FCP signaling can be reduced by constraining the possible mappings and syntax signaling.

In some implementations, a FCP value can be derived at the decoder end, which may be interpreted as the EOB value and may indicate the location of the last significant coded coefficient inside a transform unit. Based on the signaled EOB value, transform signaling can be skipped and the decoder can infer the transform type to be a default transform type such as the 2D DCT transform. For instance, an example EOB syntax is described in U.S. App. No. 63/392,943 (the contents of which are incorporated by reference in its entirety). This EOB syntax can be replaced with the FCP syntax described herein. As an example, if FCP syntax indicates that the coded block has a single coefficient (e.g., either EOB is equal to 1 or BOB is equal to 1), the transform signaling can be skipped and inferred as the default transform (e.g., 2D DCT). As another example, a transform signaling restriction can be applied only when the decoder interprets FCP as EOB (e.g., if FCP syntax is used to determine whether the only non-zero coefficient is the DC coefficient in a transform unit), while transform signaling may still be applied if FCP is used to derive BOB (first-position).

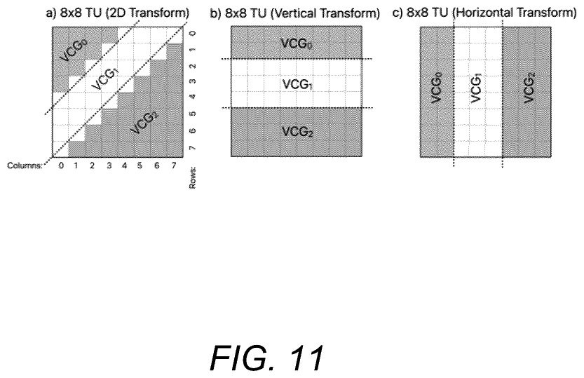

In some implementations, each logical unit (e.g., coding block or transform unit) can signal multiple FCP syntaxes, depending on different coefficient group locations or in different coefficient zones. In each coefficient group or zone, the FCP syntax can have different meanings. For instance, FIG. 11 shows variable coefficient groups (VCGs) for entropy coding (e.g., in AVM). FCP syntaxes can be signaled separately for each VCG (or zone similar to VCGs). Moreover, separate decoding decisions can be performed in each VCG.

In some implementations, based on the signaled FCP index or location, separate entropy coding models can be selected when coding and decoding other syntax elements. For instance, as shown in FIG. 10C, an FCP syntax can be transmitted after the all_zero syntax elements (e.g., in AV1 and AVM) and before the signaling a primary transform index (tx_type) or a secondary transform index/kernel (stx_type) or other transform types. Based on the relative location of the signaled FCP syntax, alternative context models for arithmetic coding can be selected to transmit a transform type index. For example, if the signaled FCP position falls into a region VCG0 in FIG. 11, a tx_type_context_set=0 can be selected. As antoher example, if the FCP position falls into a region VCG1 or VCG2, different context models can be selected (e.g., sets tx_type_context_set=1 and tx_type_context_set=2, respectively) when signaling a transform type. This can be performed for inter blocks only or for intra and inter blocks together.

In some implementations, a high level flag (e.g., a frame level, sequence level, tile level a flag) can be signaled in the picture parameter set (PPS) and/or sequence parameter set (SPS) to indicate whether FCP signaling should be enabled at the lower levels. If the high-level flag is set as 0, FCP signaling can be disabled and FCP syntax can indicate a fixed position meaning (e.g., the last position index). If the high-level flag is set as 1, FCP syntax can have different meanings (e.g., as described above).

### Example Processes

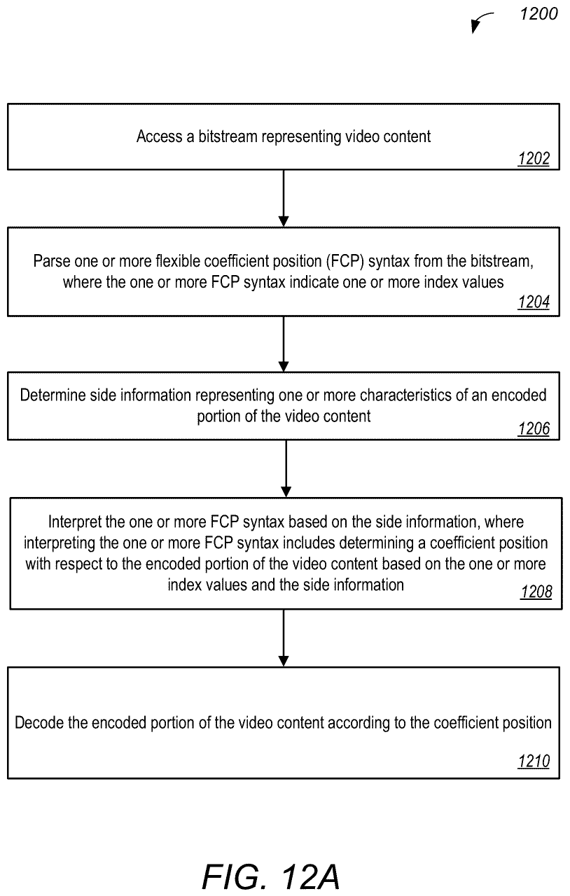

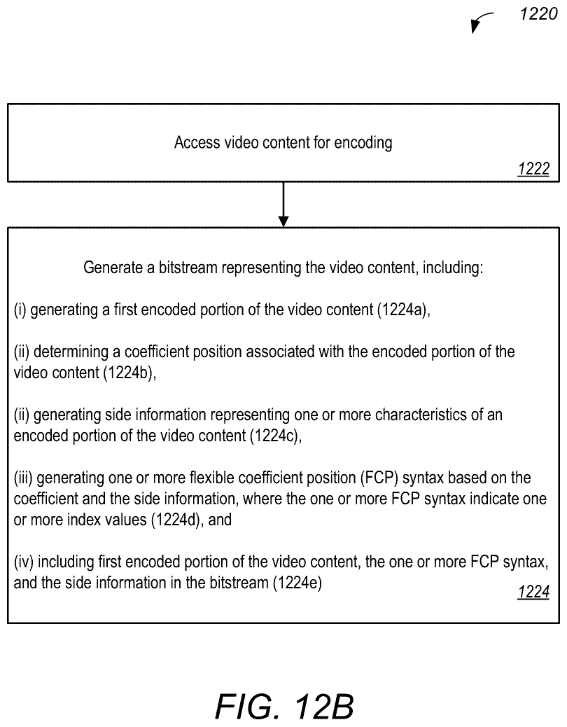

FIG. 12A shows an example process 1200 for decoding video content. The process 1200 can be performed, at least in part, using a system having a decoder (e.g., as shown in FIGS. 1, 2, 6, and 7).

According to the process 1200, a decoder accesses a bitstream representing video content (block 1202).

Further, decoder parses one or more flexible coefficient position (FCP) syntax from the bitstream, where the one or more FCP syntax indicate one or more index values (block 1204).

Further, the decoder determines side information representing one or more characteristics of an encoded portion of the video content (block 1206).

Further, the decoder interprets the one or more FCP syntax based on the side information (block 1208). Interpreting the one or more FCP syntax includes determining a coefficient position with respect to the encoded portion of the video content based on the one or more index values and the side information.

Further, the decoder decodes the encoded portion of the video content according to the coefficient position (block 1210).

In some implementations, the encoded portion of the video content can include at least one of a coding unit or a transform unit of the video content.

In some implementations, interpreting the one or more FCP syntax can include determining, based on the side information, whether the one or more FCP syntax represent (i) a sequentially first significant coefficient position of the encoded portion of the video content or (ii) a sequentially last significant coefficient position of the encoded portion of the video content.

In some implementations, interpreting the one or more FCP syntax can include determining, based on the side information, whether to decode the encoded portion of the video content according to a forward coefficient scan order or a reverse coefficient scan order.

In some implementations, interpreting the one or more FCP syntax can include determining, based on the side information, to decode the encoded portion of the video content according to the forward coefficient scan order. Decoding the encoded portion of the video content according to the coefficient position can include performing a forward coefficient scan with respect to the encoded portion of the video content starting with the coefficient position.

In some implementations, interpreting the one or more FCP syntax can include determining, based on the side information, to decode the encoded portion of the video content according to the reverse coefficient scan order. Decoding the encoded portion of the video content according to the coefficient position can include performing a reverse coefficient scan with respect to the encoded portion of the video content starting with the coefficient position.

In some implementations, the one or more FCP syntax can indicate a single index value. The coefficient position can be determined based on the single index value.

In some implementations, the one or more FCP syntax can indicate a plurality of index values. The coefficient position can be determined based on the plurality of index values.

In some implementations, the coefficient position can be determined based on one or more functions having at least some of the plurality of index values as inputs.

In some implementations, determining the side information can include determining at least one of: a transform type of the encoded portion of the video content, coding block dimensions of the encoded portion of the video content, a transform unit size of the encoded portion of the video content, a plane type of the encoded portion of the video content, a coding mode of the encoded portion of the video content, or information regarding one or more additional encoded portions of the video content neighboring the encoded portion of the video content.

In some implementations, determining the coefficient position with respect to the encoded portion of the video content can include determining a coefficient index value corresponding the coefficient position.

In some implementations, determining the coefficient position with respect to the encoded portion of the video content can include determining a coefficient column value corresponding the coefficient position.

In some implementations, determining the coefficient position with respect to the encoded portion of the video content can include determining a coefficient row value corresponding the coefficient position.

In some implementations, determining the coefficient position with respect to the encoded portion of the video content can include determining an x-coordinate corresponding the coefficient position.

In some implementations, determining the coefficient position with respect to the encoded portion of the video content can include determining a y-coordinate corresponding the coefficient position.

In some implementations, determining the side information can include determining that the encoded portion of the video content is encoded according to at least one of a discrete cosine transform (DCT) type, asymmetric discrete sine transform (ADST) type, discrete sine transform (DST) type, flipped DCT type, flipped DST type, or flipped DST type (e.g., 1D or 2D). Interpreting the one or more FCP syntax can include determining a sequentially last significant coefficient position of the encoded portion of the video content based on the one or more FCP syntax.

In some implementations, determining the side information can include determining that the encoded portion of the video content is encoded according to an identity transform type (e.g., 1D or 2D). Interpreting the one or more FCP syntax can include determining a sequentially first significant coefficient position of the encoded portion of the video content based on the one or more FCP syntax.

FIG. 12B shows an example process 1220 for encoding video content. The process 1220 can be performed, at least in part, using a system having a decoder (e.g., as shown in FIGS. 1, 2, 6, and 7).

According to the process 1220, an encoder accesses video content for encoding (block 1222)

Further, the encoder generates a bitstream representing the video content (block 1224).

Generating the bitstream includes generating a first encoded portion of the video content (block 1224a), determining a coefficient position associated with the encoded portion of the video content (block 1224b), generating side information representing one or more characteristics of an encoded portion of the video content (block 1224c), generating one or more flexible coefficient position (FCP) syntax based on the coefficient and the side information, where the one or more FCP syntax indicate one or more index values (block 1224d), and including first encoded portion of the video content, the one or more FCP syntax, and the side information in the bitstrem (block 1224e).

In some implementations, the encoded portion of the video content can include at least one of a coding unit or a transform unit of the video content.

In some implementations, generating the one or more FCP syntax can include determining whether the one or more FCP syntax represent (i) a sequentially first significant coefficient position of the encoded portion of the video content or (ii) a sequentially last significant coefficient position of the encoded portion of the video content.

In some implementations, generating the one or more FCP syntax can include determining whether the encoded portion of the video content is encoded according to a forward coefficient scan order or a reverse coefficient scan order.

In some implementations, the one or more FCP syntax can indicate a single index value.

In some implementations, the one or more FCP syntax can indicate a plurality of index values.

In some implementations, generating the side information can include generating an indication of least one of: a transform type of the encoded portion of the video content, coding block dimensions of the encoded portion of the video content, a transform unit size of the encoded portion of the video content, a plane type of the encoded portion of the video content, a coding mode of the encoded portion of the video content, or information regarding one or more additional encoded portions of the video content neighboring the encoded portion of the video content.

In some implementations, generating the one or more FCP syntax can include determining a coefficient index value corresponding the coefficient position.

In some implementations, generating the one or more FCP syntax can include determining a coefficient column value corresponding the coefficient position.

In some implementations, generating the one or more FCP syntax can include determining a coefficient row value corresponding the coefficient position.

In some implementations, generating the one or more FCP syntax can include determining an x-coordinate corresponding the coefficient position.

In some implementations, generating the one or more FCP syntax can include determining a y-coordinate corresponding the coefficient position.

### Example Computer System

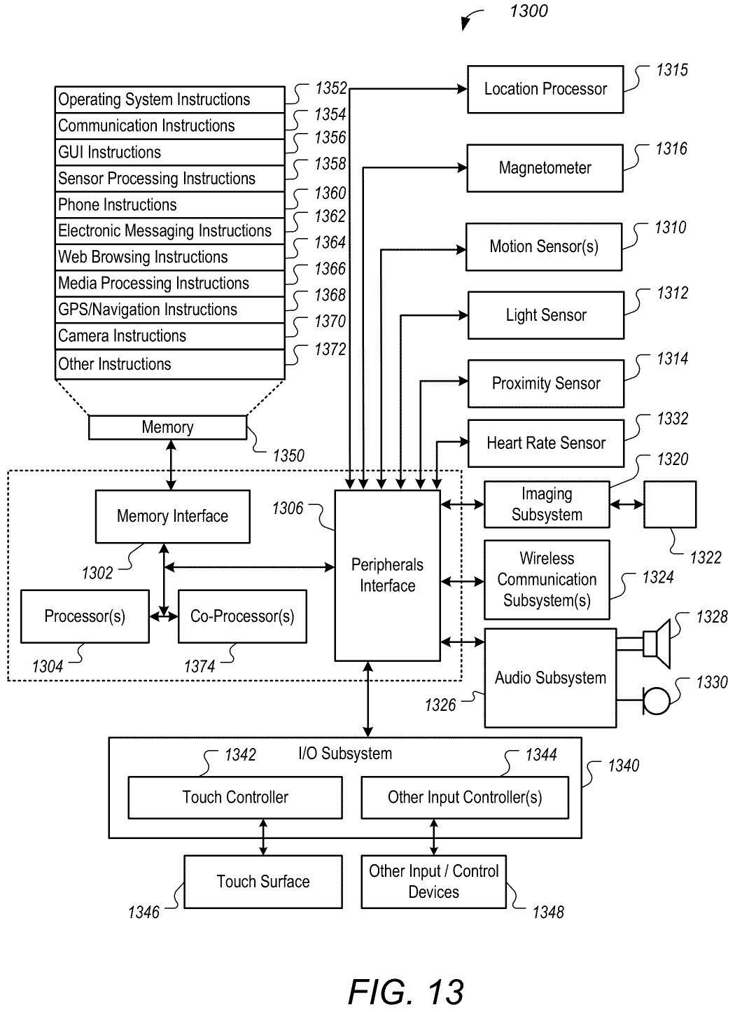

FIG. 13 is a block diagram of an example device architecture 1300 for implementing the features and processes described in reference to FIGS. 1-12B. For example, the architecture 1300 can be used to implement the system 100 and/or one or more components of the system 100. The architecture 1300 may be implemented in any device for generating the features described in reference to FIGS. 1-12B, including but not limited to desktop computers, server computers, portable computers, smart phones, tablet computers, game consoles, wearable computers, holographic displays, set top boxes, media players, smart TVs, and the like.

The architecture 1300 can include a memory interface 1302, one or more data processor 1304, one or more data co-processors 1374, and a peripherals interface 1306. The memory interface 1302, the processor(s) 1304, the co-processor(s) 1374, and/or the peripherals interface 1306 can be separate components or can be integrated in one or more integrated circuits. One or more communication buses or signal lines may couple the various components.

The processor(s) 1304 and/or the co-processor(s) 1374 can operate in conjunction to perform the operations described herein. For instance, the processor(s) 1304 can include one or more central processing units (CPUs) and/or graphics processing units (GPUs) that are configured to function as the primary computer processors for the architecture 1300. As an example, the processor(s) 1304 can be configured to perform generalized data processing tasks of the architecture 1300. Further, at least some of the data processing tasks can be offloaded to the co-processor(s) 1374. For example, specialized data processing tasks, such as processing motion data, processing image data, encrypting data, and/or performing certain types of arithmetic operations, can be offloaded to one or more specialized co-processor(s) 1374 for handling those tasks. In some cases, the processor(s) 1304 can be relatively more powerful than the co-processor(s) 1374 and/or can consume more power than the co-processor(s) 1374. This can be useful, for example, as it enables the processor(s) 1304 to handle generalized tasks quickly, while also offloading certain other tasks to co-processor(s) 1374 that may perform those tasks more efficiency and/or more effectively. In some cases, a co-processor(s) can include one or more sensors or other components (e.g., as described herein), and can be configured to process data obtained using those sensors or components, and provide the processed data to the processor(s) 1304 for further analysis.

Sensors, devices, and subsystems can be coupled to peripherals interface 1306 to facilitate multiple functionalities. For example, a motion sensor 1310, a light sensor 1312, and a proximity sensor 1314 can be coupled to the peripherals interface 1306 to facilitate orientation, lighting, and proximity functions of the architecture 1300. For example, in some implementations, a light sensor 1312 can be utilized to facilitate adjusting the brightness of a touch surface 1346. In some implementations, a motion sensor 1310 can be utilized to detect movement and orientation of the device. For example, the motion sensor 1310 can include one or more accelerometers (e.g., to measure the acceleration experienced by the motion sensor 1310 and/or the architecture 1300 over a period of time), and/or one or more compasses or gyros (e.g., to measure the orientation of the motion sensor 1310 and/or the mobile device). In some cases, the measurement information obtained by the motion sensor 1310 can be in the form of one or more a time-varying signals (e.g., a time-varying plot of an acceleration and/or an orientation over a period of time). Further, display objects or media may be presented according to a detected orientation (e.g., according to a “portrait” orientation or a “landscape” orientation). In some cases, a motion sensor 1310 can be directly integrated into a co-processor 1374 configured to processes measurements obtained by the motion sensor 1310. For example, a co-processor 1374 can include one more accelerometers, compasses, and/or gyroscopes, and can be configured to obtain sensor data from each of these sensors, process the sensor data, and transmit the processed data to the processor(s) 1304 for further analysis.

Other sensors may also be connected to the peripherals interface 1306, such as a temperature sensor, a biometric sensor, or other sensing device, to facilitate related functionalities. As an example, as shown in FIG. 13, the architecture 1300 can include a heart rate sensor 1332 that measures the beats of a user's heart. Similarly, these other sensors also can be directly integrated into one or more co-processor(s) 1374 configured to process measurements obtained from those sensors.

A location processor 1315 (e.g., a GNSS receiver chip) can be connected to the peripherals interface 1306 to provide geo-referencing. An electronic magnetometer 1316 (e.g., an integrated circuit chip) can also be connected to the peripherals interface 1306 to provide data that may be used to determine the direction of magnetic North. Thus, the electronic magnetometer 1316 can be used as an electronic compass.

An imaging subsystem 1320 and/or an optical sensor 1322 can be utilized to generate images, videos, point clouds, and/or other any other visual information regarding a subject or environment. As an example, the imaging subsystem 1320 can include one or more still cameras and/or optical sensors (e.g., a charged coupled device [CCD] or a complementary metal-oxide semiconductor [CMOS] optical sensor) configured to generate still images of a subject or environment. As another example, the imaging subsystem 1320 can include one or more video cameras and/or optical sensors configured to generate videos of a subject or environment. As another example, the imaging subsystem 1320 can include one or more depth sensors (e.g., LiDAR sensors) configured to generate a point cloud representing a subject or environment. In some implementations, at least some of the data generated the imaging subsystem 1320 and/or an optical sensor 1322 can include two-dimensional data (e.g., two-dimensional images, videos, and/or point clouds). In some implementations, at least some of the data generated the imaging subsystem 1320 and/or an optical sensor 1322 can include three-dimensional data (e.g., three-dimensional images, videos, and/or point clouds).

The information generated by the imaging subsystem 1320 and/or an optical sensor 1322 can be used to generate corresponding polygon meshes and/or to sample those polygon meshes (e.g., using the systems and/or techniques described herein). As an example, at least some of the techniques described herein can be performed at least in part using one or more data processors 1304 and/or one or more data co-processors 1374.

Communication functions may be facilitated through one or more communication subsystems 1324. The communication subsystem(s) 1324 can include one or more wireless and/or wired communication subsystems. For example, wireless communication subsystems can include radio frequency receivers and transmitters and/or optical (e.g., infrared) receivers and transmitters. As another example, wired communication system can include a port device, e.g., a Universal Serial Bus (USB) port or some other wired port connection that can be used to establish a wired connection to other computing devices, such as other communication devices, network access devices, a personal computer, a printer, a display screen, or other processing devices capable of receiving or transmitting data.

The specific design and implementation of the communication subsystem 1324 can depend on the communication network(s) or medium(s) over which the architecture 1300 is intended to operate. For example, the architecture 1300 can include wireless communication subsystems designed to operate over a global system for mobile communications (GSM) network, a GPRS network, an enhanced data GSM environment (EDGE) network, 802.x communication networks (e.g., Wi-Fi, Wi-Max), code division multiple access (CDMA) networks, NFC and a Bluetooth™ network. The wireless communication subsystems can also include hosting protocols such that the architecture 1300 can be configured as a base station for other wireless devices. As another example, the communication subsystems may allow the architecture 1300 to synchronize with a host device using one or more protocols, such as, for example, the TCP/IP protocol, HTTP protocol, UDP protocol, and any other known protocol.

An audio subsystem 1326 can be coupled to a speaker 1328 and one or more microphones 1330 to facilitate voice-enabled functions, such as voice recognition, voice replication, digital recording, and telephony functions.

An I/O subsystem 1340 can include a touch controller 1342 and/or other input controller(s) 1344. The touch controller 1342 can be coupled to a touch surface 1346. The touch surface 1346 and the touch controller 1342 can, for example, detect contact and movement or break thereof using any of a number of touch sensitivity technologies, including but not limited to capacitive, resistive, infrared, and surface acoustic wave technologies, as well as other proximity sensor arrays or other elements for determining one or more points of contact with the touch surface 1346. In one implementation, the touch surface 1346 can display virtual or soft buttons and a virtual keyboard, which can be used as an input/output device by the user.

Other input controller(s) 1344 can be coupled to other input/control devices 1348, such as one or more buttons, rocker switches, thumb-wheel, infrared port, USB port, and/or a pointer device such as a stylus. The one or more buttons (not shown) can include an up/down button for volume control of the speaker 1328 and/or the microphone 1330.

In some implementations, the architecture 1300 can present recorded audio and/or video files, such as MP3, AAC, and MPEG video files. In some implementations, the architecture 1300 can include the functionality of an MP3 player and may include a pin connector for tethering to other devices. Other input/output and control devices may be used.

A memory interface 1302 can be coupled to a memory 1350. The memory 1350 can include high-speed random access memory or non-volatile memory, such as one or more magnetic disk storage devices, one or more optical storage devices, or flash memory (e.g., NAND, NOR). The memory 1350 can store an operating system 1352, such as MACOS, IOS, Darwin, RTXC, LINUX, UNIX, WINDOWS, or an embedded operating system such as VxWorks. The operating system 1352 can include instructions for handling basic system services and for performing hardware dependent tasks. In some implementations, the operating system 1352 can include a kernel (e.g., UNIX kernel).

The memory 1350 can also store communication instructions 1354 to facilitate communicating with one or more additional devices, one or more computers or servers, including peer-to-peer communications. The communication instructions 1354 can also be used to select an operational mode or communication medium for use by the device, based on a geographic location (obtained by the GPS/Navigation instructions 1368) of the device. The memory 1350 can include graphical user interface instructions 1356 to facilitate graphic user interface processing, including a touch model for interpreting touch inputs and gestures; sensor processing instructions 1358 to facilitate sensor-related processing and functions; phone instructions 1360 to facilitate phone-related processes and functions; electronic messaging instructions 1362 to facilitate electronic-messaging related processes and functions; web browsing instructions 1364 to facilitate web browsing-related processes and functions; media processing instructions 1366 to facilitate media processing-related processes and functions; GPS/Navigation instructions 1369 to facilitate GPS and navigation-related processes; camera instructions 1370 to facilitate camera-related processes and functions; and other instructions 1372 for performing some or all of the processes described herein.

Each of the above identified instructions and applications can correspond to a set of instructions for performing one or more functions described herein. These instructions need not be implemented as separate software programs, procedures, or modules. The memory 1350 can include additional instructions or fewer instructions. Furthermore, various functions of the device may be implemented in hardware and/or in software, including in one or more signal processing and/or application specific integrated circuits (ASICs).

The features described may be implemented in digital electronic circuitry or in computer hardware, firmware, software, or in combinations of them. The features may be implemented in a computer program product tangibly embodied in an information carrier, e.g., in a machine-readable storage device, for execution by a programmable processor; and method steps may be performed by a programmable processor executing a program of instructions to perform functions of the described implementations by operating on input data and generating output.

The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer may communicate with mass storage devices for storing data files. These mass storage devices may include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user the features may be implemented on a computer having a display device such as a CRT (cathode ray tube) or LCD (liquid crystal display) monitor for displaying information to the author and a keyboard and a pointing device such as a mouse or a trackball by which the author may provide input to the computer.

The features may be implemented in a computer system that includes a back-end component, such as a data server or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include a LAN, a WAN and the computers and networks forming the Internet.

The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an Application Programming Interface (API). An API may define on or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

As described above, some aspects of the subject matter of this specification include gathering and use of mesh and point cloud data available from various sources to improve services a mobile device can provide to a user. The present disclosure further contemplates that to the extent mesh and point cloud data representative of personal information data are collected, analyzed, disclosed, transferred, stored, or otherwise used, implementors will comply with well-established privacy policies and/or privacy practices. In particular, such implementers should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such implementers would take any needed steps for safeguarding and securing access to such personal information data and ensuring that others with access to the personal information data adhere to their privacy policies and procedures. Further, such implementers can subject themselves to evaluation by third parties to certify their adherence to widely accepted privacy policies and practices.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising:
accessing, by one or more processors, a bitstream representing video content;
parsing, by the one or more processors, one or more flexible coefficient position (FCP) syntax from the bitstream, wherein the one or more FCP syntax indicate one or more index values;
determining, by the one or more processors, side information representing one or more characteristics of an encoded portion of the video content;
interpreting, by the one or more processors, the one or more FCP syntax based on the side information, wherein interpreting the one or more FCP syntax comprises determining a coefficient position with respect to the encoded portion of the video content based on the one or more index values and the side information; and
decoding, by the one or more processors, the encoded portion of the video content according to the coefficient position.

2. The method of claim 1, wherein the encoded portion of the video content comprises at least one of a coding unit or a transform unit of the video content.

3. The method of claim 1, wherein interpreting the one or more FCP syntax comprises:
determining, based on the side information, whether the one or more FCP syntax represent (i) a sequentially first significant coefficient position of the encoded portion of the video content or (ii) a sequentially last significant coefficient position of the encoded portion of the video content.

4. The method of claim 1, wherein interpreting the one or more FCP syntax comprises:
determining, based on the side information, whether to decode the encoded portion of the video content according to a forward coefficient scan order or a reverse coefficient scan order.

5. The method of claim 4, wherein interpreting the one or more FCP syntax comprises determining, based on the side information, to decode the encoded portion of the video content according to the forward coefficient scan order, and
wherein decoding the encoded portion of the video content according to the coefficient position comprises performing a forward coefficient scan with respect to the encoded portion of the video content starting with the coefficient position, wherein the coefficient is a first coded coefficient position.

6. The method of claim 4, wherein interpreting the one or more FCP syntax comprises determining, based on the side information, to decode the encoded portion of the video content according to the reverse coefficient scan order, and
wherein decoding the encoded portion of the video content according to the coefficient position comprises performing a reverse coefficient scan with respect to the encoded portion of the video content starting with the coefficient position wherein the coefficient is a last coded coefficient position.

7. The method of claim 1, wherein the one or more FCP syntax indicate a single index value, and
wherein the coefficient position is determined based on the single index value.

8. The method of claim 1, wherein the one or more FCP syntax indicate a plurality of index values, and
wherein the coefficient position is determined based on the plurality of index values.

9. The method of claim 8, wherein the coefficient position is determined based on one or more functions having at least some of the plurality of index values as inputs.

10. The method of claim 1, wherein determining the side information comprises determining at least one of:
a transform type of the encoded portion of the video content,
coding block dimensions of the encoded portion of the video content,
a transform unit size of the encoded portion of the video content,
a plane type of the encoded portion of the video content,
a coding mode of the encoded portion of the video content, or
information regarding one or more additional encoded portions of the video content neighboring the encoded portion of the video content.

11. The method of claim 1, wherein determining the coefficient position with respect to the encoded portion of the video content comprises:
determining a coefficient index value corresponding the coefficient position.

12. The method of claim 1, wherein determining the coefficient position with respect to the encoded portion of the video content comprises:
determining a coefficient column value corresponding the coefficient position.

13. The method of claim 1, wherein determining the coefficient position with respect to the encoded portion of the video content comprises:
determining a coefficient row value corresponding the coefficient position.

14. The method of claim 1, wherein determining the coefficient position with respect to the encoded portion of the video content comprises:
determining an x-coordinate corresponding the coefficient position.

15. The method of claim 1, wherein determining the coefficient position with respect to the encoded portion of the video content comprises:
determining a y-coordinate corresponding the coefficient position.

16. The method of claim 1, wherein determining the side information comprises determining that the encoded portion of the video content is encoded according to at least one of a discrete cosine transform (DCT) type, asymmetric discrete sine transform (ADST) type, discrete sine transform (DST) type, flipped DCT type, flipped DST type, or flipped DST type, and
wherein interpreting the one or more FCP syntax comprises determining a sequentially last significant coefficient position of the encoded portion of the video content based on the one or more FCP syntax.

17. The method of claim 1, wherein determining the side information comprises determining that the encoded portion of the video content is encoded according to an identity transform type, and
wherein interpreting the one or more FCP syntax comprises determining a sequentially first significant coefficient position of the encoded portion of the video content based on the one or more FCP syntax.

18. A system comprising:
one or more processors; and
one or more non-transitory computer readable media storing instructions that, when executed by the one or more processors, cause the one or more processors to perform operation comprising:
accessing a bitstream representing video content;
parsing one or more flexible coefficient position (FCP) syntax from the bitstream, wherein the one or more FCP syntax indicate one or more index values;
determining side information representing one or more characteristics of an encoded portion of the video content;
interpreting the one or more FCP syntax based on the side information, wherein interpreting the one or more FCP syntax comprises determining a coefficient position with respect to the encoded portion of the video content based on the one or more index values and the side information; and
decoding the encoded portion of the video content according to the coefficient position.

19. One or more non-transitory computer readable media storing instructions that, when executed by one or more processors, cause the one or more processors to perform operation comprising:
accessing a bitstream representing video content;
parsing one or more flexible coefficient position (FCP) syntax from the bitstream, wherein the one or more FCP syntax indicate one or more index values;
determining side information representing one or more characteristics of an encoded portion of the video content;
interpreting the one or more FCP syntax based on the side information, wherein interpreting the one or more FCP syntax comprises determining a coefficient position with respect to the encoded portion of the video content based on the one or more index values and the side information; and
decoding the encoded portion of the video content according to the coefficient position

20. A method comprising:
accessing, by one or more processors, video content for encoding; and
generating, by the one or more processors, a bitstream representing the video content, wherein generating the bitstream comprises:
generating a first encoded portion of the video content,
determining a coefficient position associated with the encoded portion of the video content,
generating side information representing one or more characteristics of an encoded portion of the video content,
generating one or more flexible coefficient position (FCP) syntax based on the coefficient and the side information, wherein the one or more FCP syntax indicate one or more index values, and
including first encoded portion of the video content, the one or more FCP syntax, and the side information in the bitstream.

21.-33. (canceled)
